(19) United States
(12) Patent Application Publication
(10) Pub. No.: US 2022/0090410 A1
(43) Pub. Date: Mar. 24, 2022

(54) HANDLE ASSEMBLY

(71) Applicant: AANCO (UK) LIMITED, Billingham (GB)

(72) Inventors: Ashley GAUNT, Egglescliffe (GB); Thomas FIELDING, Stockton-on-Tees (GB)

(21) Appl. No.: 17/420,390

(22) PCT Filed: Jan. 3, 2020
(86) PCT No.: PCT/GB2020/050005

§ 371 Date: Jul. 1, 2021

(30) Foreign Application Priority Data
Jan. 3, 2019 (GB) 1900075.1

(51) Int. Cl. E05B 5/02; E05B 5/00

(52) U.S. Cl. CPC E05B 5/003; E05B 5/006

(57) ABSTRACT

The present invention relates to a handle assembly for a door having a locking mechanism. The handle assembly comprises a handle; a housing adapted to receive and store the handle; and a handle release assembly. The handle release assembly comprises an activation release mechanism adapted to selective move the handle from a stored inoperable position into a released operable position, and a translation mechanism adapted to move the handle rotatably about and axially along an axis normal to the planar surface of the housing during operation.

This present invention relates to a handle assembly, in particular, but not exclusively, to a storable handle assembly for use in doors, windows and bifold doors having a locking mechanism.

### BACKGROUND

Handle assemblies in the prior art typically comprise handles, knobs, arms and the like. In many instances, the handle assembly protrudes from a surface of, for example, a door or a window which allows a user to easily grip and operate the handle. However, this feature is often not desirable where multiple surfaces comprising the handle assemblies slide and fold relative to one another, such as in a bifold door arrangement where it is advantageous for the handle to remain very close to the door as it poses an obstruction. When a door must open, it can end up close to a proximal door, or to a wall. It is also beneficial for aesthetic purposes to have a handle remain flush or at least very close with the door. However, to maintain ergonomics the handle must protrude when needed such that it can be handled or gripped easily. To address these issues, handle assemblies which are flush with the surface have been introduced. However, such handle assemblies are deprived of the benefit where a user can easily grip and operate the handle.

It is an object of the invention to alleviate or mitigate at least one or more of the aforementioned problems.

### BRIEF SUMMARY OF THE DISCLOSURE

The present invention is defined in the appended claims.

In accordance with the present invention there is provided a handle assembly, and a method of operating a handle assembly according to the appended claims. Embodiments of the invention are defined in the dependent claims.

According to an aspect, the present invention provides a handle assembly. The handle assembly comprises a handle; a housing adapted to receive and store the handle; and a handle release assembly. The handle release assembly comprises an activation release mechanism adapted to selectively move the handle from a stored inoperable position into a released operable position, and a translation mechanism adapted to move the handle rotatably about and axially along an axis normal to the planar surface of the housing during operation

In this way, the present invention provides a handle assembly which can be in a stored position where the handle is retained in the housing or it can be in a released position where the handle is no longer contained and restricted within the housing. In this way, the handle is released from the housing and can be operated by the user. The user can employ the stored position or the released position depending on the situation. For example, a user may employ the stored position to prevent the handle from interfering with other components as is the case for sliding bifold doors, for example, where the handle would otherwise protrude from the surface and obstruct proximal doors. The stored position can be used such that the handle is retained inside the housing. In the released position, there is a larger area for a user to engage with the handle, enabling the user to easily grasp and operate the handle.

In certain embodiments, the activation release mechanism comprises a push latch operatively coupled to a portion of the handle and adapted to selectively operatively engage with the handle and to release the handle from the stored inoperable position. In this way, a user can engage and more readily release the handle out of the housing. For example, advantageously, the user may push the handle from the front surface to release the handle, presenting the handle to the user, ready to be turned. The user may then push the mechanism a sequential time to return the handle to the stored position. This feature, in combination with a biasing element may allow the handle to return to the stored position, particularly such that the handle remains parallel to the plane of the door. The handle may then return to the stored position under spring pressure.

In certain embodiments, the push latch comprises at least one first biasing member.

In certain embodiments, the at least one first biasing member comprises a helical spring operatively engaged with the handle.

In certain embodiments, the activation release mechanism comprises a pull latch on or in a portion of the handle and configured such that a user can engage the pull latch to release the handle from the stored inoperable position. In this way, a user can engage with and more readily release the handle out of the housing. For example, advantageously, the user may pull the handle to release it from the housing ready to be turned. The user may then push the handle to return the handle it to the stored position. This feature, in combination with a biasing element may allow the handle to return to the stored position, particularly such that the handle remains parallel to the plane of the door. The handle may then return to the stored position under spring pressure. A further advantage of the pull latch is the simplified design compared to a push latch, which requires higher manufacturing tolerances to provide reliable operation of the push latch mechanism.

In certain embodiments the pull latch comprises a tab on the handle. In certain embodiments, the pull latch comprises a recess or aperture in the handle. In these ways, a user may interact with the tab, recess or aperture to pull the handle out of the stored inoperable position into the released operable position.

In certain embodiments, the housing comprises a stop (e.g. a protrusion) adapted to selectively operatively engage with the handle to prevent the handle recessing into the housing. More specifically, the protrusion extends into a cavity formed by the housing and is configured to engage a rear surface of the handle. In this way, the front surface of the handle is prevented from substantially recessing into the housing. In some cases the pull latch may be formed from an end of the handle.

In certain embodiments, the handle comprises a second recess adapted to receive and engage with the protrusion of the housing. More specifically, the handle comprises the second recess in a rear surface.

In certain embodiments, the translation mechanism comprises a first cam system adapted to allow simultaneous movement of the handle rotatably about and axially along the axis normal to the planar surface of the housing during operation.

In certain embodiments, the first cam system comprises a cam profile provided on the handle cooperatively coupled to a corresponding cam surface provided on the housing.

In certain embodiments, the handle release assembly further comprises a mount configured to rotatably couple the handle to the housing.

In certain embodiments, the mount comprises at least one second biasing element configured to resiliently bias the handle towards the housing. Advantageously, if the handle is left in the released position, it can bias and return the handle a distance back into the housing under the effect of the second biasing element, such that the handle and the door remain undamaged.

In certain embodiments, the at least one second biasing element is a torsion (pivot) spring operatively engageable with the mount.

In certain embodiments, the at least one second biasing element provides a second biasing force that is lesser than a first biasing force provided by the at least one first biasing member. By having at least a second biasing element configured to provide a second biasing force in a direction into the housing, the second biasing force acts to always pull the handle towards the housing (i.e. parallel to the plane of the door). However, when the second biasing force is overcome by the first biasing force provided by the at least one first biasing member, the handle can be biased from its stored position to a released position, where a user can grip the handle over a larger surface area, making it easier to operate the handle.

In certain embodiments, the at least one first biasing member is configured to operatively couple to a second cam system.

In certain embodiments, the housing comprises at least one stopping portion adapted to operably engage the handle when it is rotated 90° relative to the housing.

In certain embodiments, when the handle is in the stored inoperable position, the front surface of the handle is arranged substantially flush with the outer surface of the housing.

In certain embodiments, when the handle is in the stored inoperable position, the front surface of the handle is arranged sub-flush with the outer surface of the housing.

In certain embodiments, the handle assembly further comprises a stopping portion adapted to operatively engage with the handle. In this way, the handle is not able to contact the housing portion and damage the handle assembly.

In certain embodiments, when the handle is in the stored inoperable position, the front surface of the handle is substantially parallel with the outer surface of the housing. This prevents parts of the handle protruding a distance greater than other parts of the handle, which may come into contact with doors, other fixtures or parts of the handle assembly.

In certain embodiments, when the handle is in the released operable position, the front surface of the handle is substantially parallel with the outer surface of the housing.

In certain embodiments, when the handle is in the released operable position, the front surface of the handle protrudes a distance of less than 9 mm from the outer surface of the housing. Again, this prevents parts of the handle coming into contact with other components such as other doors, fixtures or parts of the handle assembly.

In certain embodiments, the housing comprises an attachment portion adapted to operatively receive a corresponding attachment portion of the handle.

In certain embodiments, when the handle is in the stored inoperable position, the handle is fixed relative to the housing such that the handle cannot rotate therein. Thus, the introduction of a back-torque on the handle cannot open the door, helping improve the security of the door.

### BRIEF DESCRIPTION OF THE DRAWINGS

Embodiments of the invention are further described hereinafter with reference to the accompanying drawings, in which:

FIG. 1A illustrates a front perspective view of a handle assembly housing according to an embodiment of the present invention.

FIG. 1B illustrates a front view of the housing in FIG. 1A.

FIG. 2A illustrates a rear perspective view of the handle assembly housing according to an embodiment of the present invention.

FIG. 2B illustrates a rear view of the housing in FIG. 2A.

FIG. 3A illustrates a front perspective view of a handle according to an embodiment of the present invention.

FIG. 3B illustrates a front view of the handle in FIG. 3A.

FIG. 4A illustrates a rear perspective view of a handle according to an embodiment of the present invention.

FIG. 4B illustrates a rear view of the handle in FIG. 4A.

FIG. 5 illustrates an exploded view of a latch assembly according to an embodiment of the present invention.

FIG. 6A illustrates a detailed perspective view of a piston from the latch assembly according to an embodiment of the present invention.

FIG. 6B illustrates a detailed plan view of the piston in FIG. 6A.

FIG. 7A illustrates a front perspective view of a handle assembly housing according to a further embodiment of the present invention.

FIG. 7B illustrates a front view of the housing in FIG. 7A.

FIG. 8A illustrates a rear perspective view of a handle according to a further embodiment of the present invention.

FIG. 8B illustrates a rear view of the handle in FIG. 8A.

FIG. 9 illustrates a perspective view of an alternative handle assembly.

FIGS. 10A to 100 illustrate perspective cross-sectional views of a protrusion and recess which inter-engage to secure the handle.

FIGS. 11A and 11B illustrate perspective views of a cam system of the handle assembly.

FIGS. 12A and 12B illustrate perspective views of cam surfaces of the cam system.

### DETAILED DESCRIPTION

Like reference numerals are used to depict like features throughout.

As used herein, “inner” or “inward” or “front” denotes a direction that is generally inward towards the door and “outer”, “outward”, “rear” or “back” denotes a direction that is generally outward of the door.

As used herein, the terms “proximal” and “distal” are positioned relative to the portion mounted to the door (i.e. the mounting portion 18, which will be described).

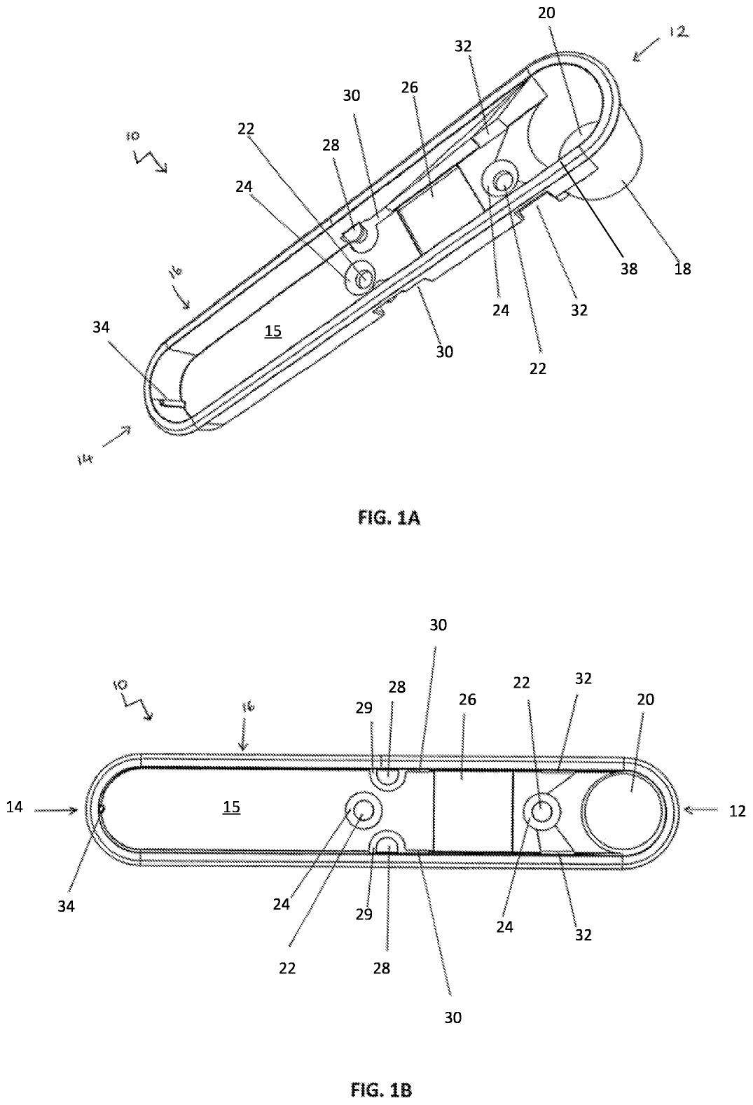

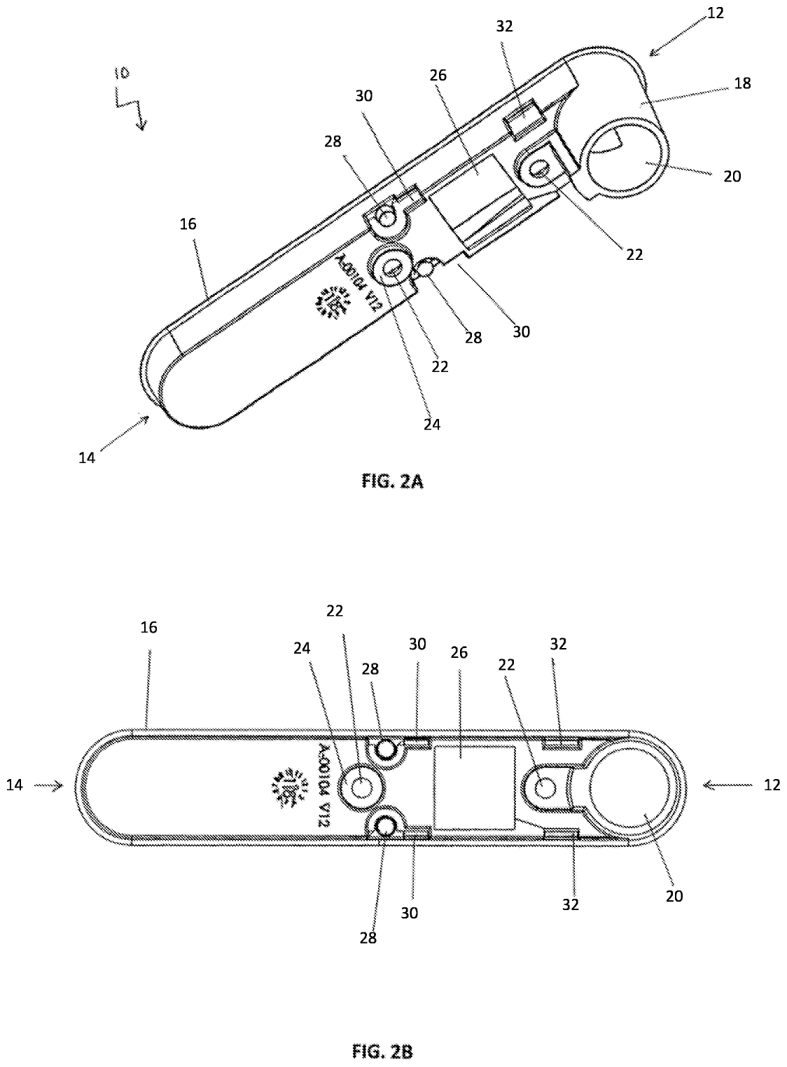

FIG. 1A illustrates a front perspective view of a housing member (herein described as “housing”) 10 for use in a sliding door (not shown) and FIG. 1B illustrates a front view of same. The housing 10 is an elongate member having a proximal end 12 and a distal end 14. The housing 10 has a thin outer wall 16 defining an outer surface of the housing 10 which extends the entire edge of the housing 10. A tubular mounting portion 18 is located at the proximal end 12 of the housing 10 and protrudes from a rear surface of the housing 10, as is better seen in FIG. 2A. The mounting portion 18 has a bore extending through the length of the mounting portion 18 that is configured to receive a mount (not shown). In this example, the mounting portion 18 is tubular in shape, but it should be appreciated that the mounting portion 18 may have other shapes that are not tubular in accordance with the present disclosure. It should also be appreciated that the mount received in the mounting portion 18 may be a pin, a barrel, a spindle, or other hinge members or fasteners according to the present disclosure.

A square shaped cut-out 26 is located towards the centre of a recessed surface 15 of the housing. The function of this cut-out 26 will later be made apparent. Also located on the recessed surface 15 are two mounting apertures 22. These are countersunk, forming a radius 24 around the mounting apertures 22. Fasteners (not shown) are inserted into the mounting apertures 22 to mount the housing 10 onto a gearbox (not shown) which is coupled to pushrods that engage with the latching mechanism of the door to lock and unlock the door. In this example, the mounting apertures mount the housing to a gearbox which engages with the latching mechanism of the door. However, it should be appreciated that the housing 10 can be mounted onto a door. It should further be appreciated that the housing 10 can be mounting onto other fixtures such as, but not limited to, windows, shutters, bi-fold doors. It should further be appreciated that the housing 10 can be mounted onto these fixtures by other means such as screws, rivets, adhesives, or other fastening means. Two pairs of slots 30, 32 are disposed on the outer wall 16 of the housing 10. More specifically, two slots 32 are disposed on either side of the outer wall 16 near on the proximal side of the cut-out 26 and two slots 30 are disposed on the distal side of the cut-out 26. Receiving portions 28 extend from a surface of the outer wall 16 above the slots 30. The slots 30,32 and the receiving portions 28 are configured to receive wing portions (not shown) of a handle insert (not shown). The housing 10 has a wedge member 34 located at the distal end 14, at the inner surface of the outer wall 16. This wedge member 34 is configured to receive a portion of the handle 40, which will be described.

FIG. 2A illustrates a rear perspective view and FIG. 2B illustrates a rear view of the housing 10. The radius 24 of the mounting aperture on the recessed surface 15 protrudes from the rear surface of the housing 10. This radius 24 allows extra room for fasteners to be received into the recessed surface 15 when the housing 10 is mounted onto a door.

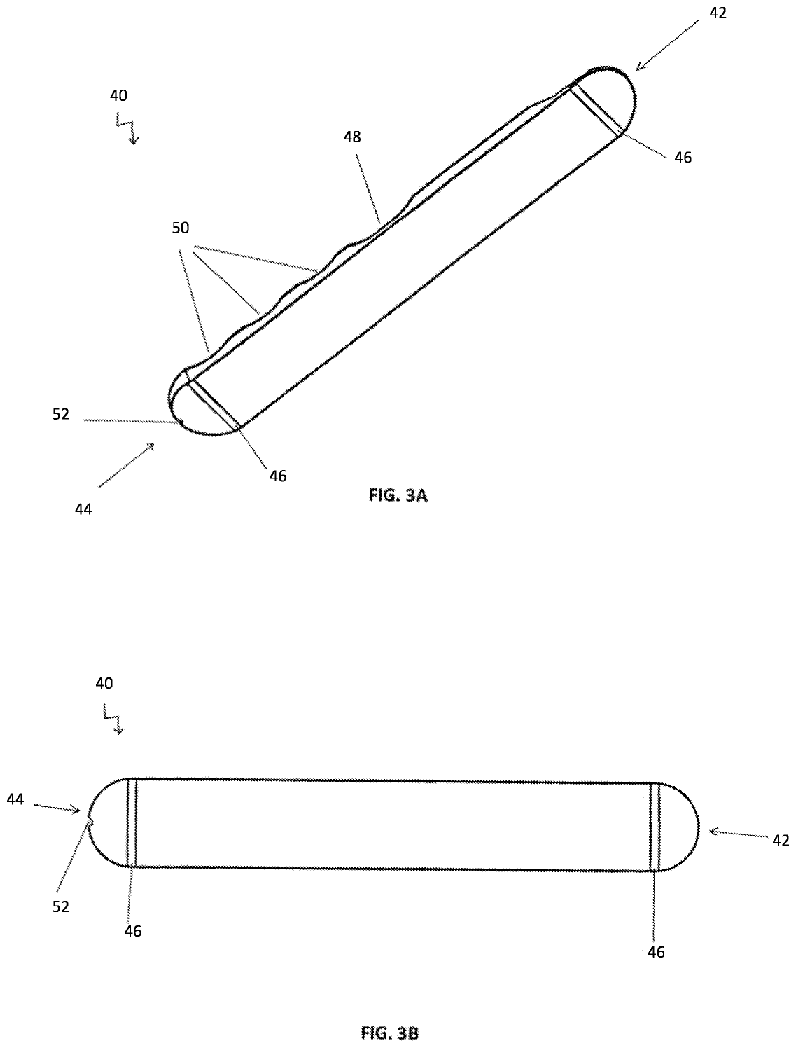

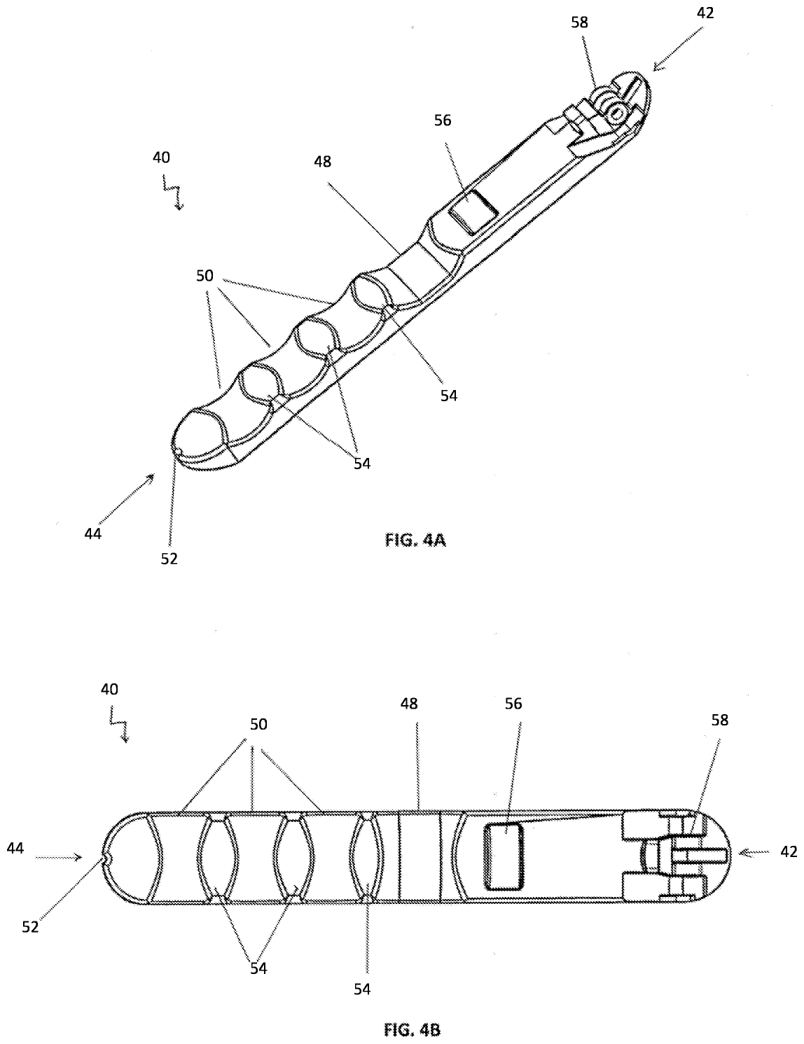

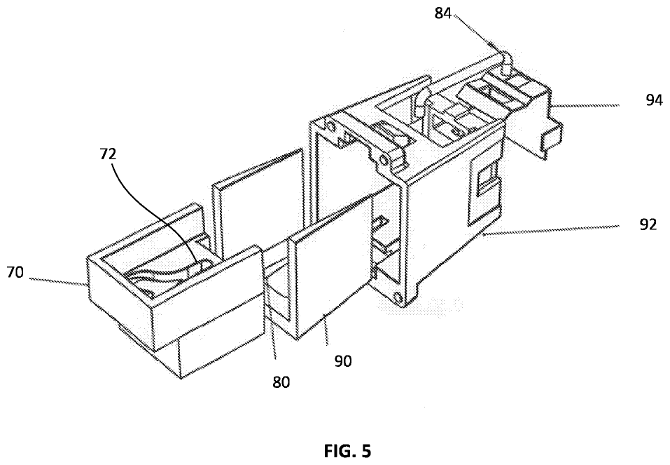

FIG. 3A illustrates a front perspective view of a handle 40 and FIG. 3B illustrates a front view of same. The handle 40 is an elongate element having a proximal end 42 and a distal end 44 which are folded inwards along lines 46. The handle 40 has a notch 52 at the distal end 44. In this example, the notch is a “U” shape, however, it should be appreciated that the notch can have other shapes, such as a “V” shape, trapezoidal or square shaped. The notch 52 is configured to align and engage with the wedge member 34 of the housing 10 so as to align the axes of the housing 10 and the handle 40 such that the handle 40 is received and stored in the housing 10, and further so that the handle can be housed parallel to the door plane. The handle 40 has a front surface that is arranged flush with the outer wall/surface 16 of the housing 10. In this example, the handle has a front surface that is arranged flush with the outer wall/surface 16 of the housing, however it should be appreciated that the front surface can be arranged substantially flush with the outer wall/surface, such as an example where the plane of the front surface is 3 mm beyond the surface of the outer wall/surface of the housing. Not only does this lock the handle 40 in the housing 10 such that the handle cannot rotate therein, the introduction of a back-torque cannot rotate the handle 40 either. More specifically, the handle 40 is coupled to door latching mechanism (not shown) via a gearbox coupling mechanism (not shown) inside the door which couples with pushrods that intersect upper and lower parts of the door frame to lock the rotate. Rotation of the gearbox input shaft unlocks the door. It is therefore foreseen that back torques arriving from forces from the gearbox such as when the pushrods are forced back inwards can rotate the handle. By allowing the handle 40 to be received and stored inside the housing 10, the introduction of a back torque (such as when a burglar tries to force the door open by forcing the pushrods back inwards) will not rotate the handle 40. According to the present disclosure, the front surface can be arranged sub-flush to the outer wall/surface 16, which further blocks the rotation of the handle 40 since it is received and stored inside the housing 10. The wedge member 34 may be received in the notch 52. The handle 40 has gripping portions 50 and a concave section 48 on the rear side, as is better seen in FIGS. 4A and 4B. In this example, the housing comprises a wedge member and the handle comprises a notch, however it should be appreciated that the housing may comprise a notch and the handle may comprise a wedge member according to the present disclosure. It should further be appreciated that the housing may comprise any male or female attachment portion and the handle may comprise the corresponding attachment portion according to the present disclosure.

FIG. 4A illustrates a rear perspective view and FIG. 4B illustrates a rear view of the handle. The gripping portions 50 on the rear side of the handle 40 are each separated by intermediate portions 54. The gripping portions 50 provide a curved surface for the user to place their fingers to grip the handle 40 and the intermediate portions 54 provides separation to the fingers in order to increase the span of area that can be gripped by the user. The rear side of the handle 40 has a protruding portion 56 disposed between the concave section 48 and the proximal end 42. When the handle 40 is aligned with the housing 10 via the wedge member 34 and the notch 52, the protruding portion 56 aligns with the cut-out 26. This allows the handle 40 to be received inside the housing 10 such that the rear surface of the handle 40 is received on the recessed surface 15 of the housing 10, and the protruding portion 56 projects through the cut-out 26.

With reference to FIGS. 1A and 4A, the handle assembly comprising the handle 40 and the housing 10 in the stowed inoperable position will now be described. The housing 10 is mounted onto the door (not shown) by fasteners received in the mounting apertures 22 to secure the housing 10 thereon. The mounting portion 18 is configured to receive a mount (not shown) through the bore 20 such that the mount is retained in the bore 20. As mentioned, the mount and the handle 40 are rotatably coupled. The handle 40 is received and stored in the housing 10 in the stored position. In this stored position, the front surface of the handle 40 is flush against the outer surface of the housing 10 and the wedge member 34 is received in the notch 52 so as to align the housing 10 and the handle 40. When the handle 40 is received and stored in the housing 10, the protruding portion 56 of the handle 40 projects through the cut-out 26 to be engaged with the activation release mechanism, as will be discussed.

At the proximal end 42 of the handle 40, there is located a hinge 58 configured to attach the mount (not shown) to the handle 40. The hinge 58 comprises a second biasing element (not shown) that is configured to resiliently bias the handle 40 into the housing 10. More specifically, the second biasing element is a torsion spring disposed around the hinge 58 which acts to pull the handle flat towards the door plane. The mount allows the handle 40 to rotate relative to the housing 10. The handle also comprises a translation element (not shown) that is adapted to rotate relative to the housing, allowing the handle 40 to rotate relative to the housing. The translation element translates relative to the housing, and is further adapted to simultaneously rotate and translate relative to the housing. Specifically, the translation element is part of a translation mechanism that comprises a cam system adapted to allow simultaneous movement of the handle 40 rotatably about and axially along the axis normal to the planar surface of the housing 40 when the handle 40 is operated. This is achieved by having a cam profile provided on the handle 40 which cooperatively couples to a corresponding cam surface (not shown) provided to the housing 10. In this way, the handle 40 can more easily clear the housing 10 so as to rotate the handle 40 without being interposed by the housing 10. Specifically, the translation element is a cam surface (not shown) that engages with handle pins (not shown) which translates the handle away from the door plane as the handle is turned.

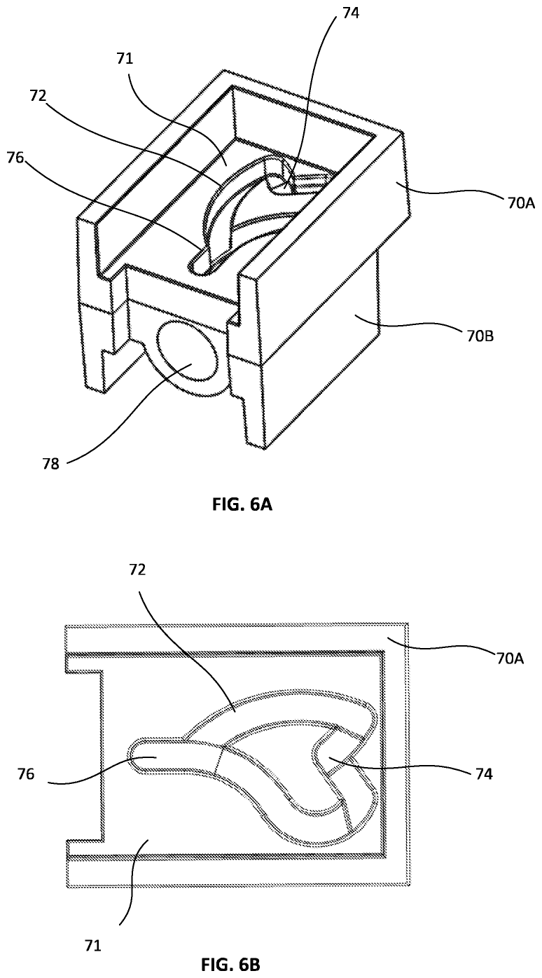

FIG. 5 illustrates exploded view of the activation release mechanism assembly comprising a piston 70 having a top section 70A and a bottom section 70B, as seen in FIG. 6A. The top section 70A has a base 71 comprising a cam profile 72 configured to receive a linking rod member 84. The bottom section 70B has a housing member 78 configured to receive a first biasing member 80. In this example, the first biasing member 80 is a helical/compression spring, however it should be appreciated that the first biasing member can take other forms according to the present disclosure and still bias the piston relate to the latch housing 92. The activation release mechanism also comprises a piston wedge 90 that is received in a latch housing 92. The activation release mechanism assembly is secured in place by a retaining clip 84 that folds to hold the assembly together. A first end of the rod member 84 is received in the cam profile 72 and the second end of the rod member 84 is received in the latch housing. The rod member 84 is coupled to the first biasing member 80 such that the piston 70 can move in and out of the latch housing when the rod member moves along the cam profile 72. The cam profile has a high initial angle.

The activation release mechanism assembly located in the cut-out 26 of the housing 10 is disposed on the surface of the door (not shown) so that the activation release mechanism engages with the protruding portion 56 of the handle 40. When the handle 40 is in the stored position, the first biasing member 80 is compressed, where the rod member 84 is received in a first position 74 of the cam profile 72 (see FIG. 6B). In the stored position, the handle 40 is received and stored in the housing 10 so that the front surface of the handle 40 is flush with the outer surface of the housing 10. In this example, the handle is flush with the housing, however it is envisaged that the handle 40 can be sub-flush with the housing 10 according to the present disclosure. That is to say that the handle 40 is recessed a distance into the housing 10. To actuate the activation release mechanism to release the handle 40 from the stored position in the housing 10 to a released position out of the housing 10, a user can provide a pressing force (i.e. push) the handle 10 into the housing 40 to further compress the first biasing member 80, and the when the user releases the pressing force, the rod member 84 moves from the first position 74 in the cam profile 72, along the cam profile 72 and into the second position 76, where the first biasing member 80 is decompressed, pushing the piston 70 in a direction out of latch housing 92, which in turn moves the handle from a stored position, where the handle cannot be rotated relative to the housing (i.e. is inoperable) to a released position out of the housing 10, where the handle 40 can be rotated relative to the housing 10 (i.e. operable). For example, when the handle 40 can be rotated relative to the housing 10 from an angle 0° to an angle of 90° to a deployed position. The deployed position may align the handle 40 with the sliding direction of the door so as to require less force to open the door. In this example, the handle is configured to open a sliding door. However, it is to be envisaged that the handle assembly can be used to open a bifold door, where the handle is used to push or pull on the outward movement of the door, before a user slides the door along the track of the bifold door assembly typically by using the back side of one of the doors in the assembly which door has just been opened. When the handle 40 is rotated, the handle 40 remains parallel to the plane of the door. The handle also comprises a translation element (not shown) that is adapted to rotate relative to the housing, allowing the handle 40 to rotate relative to the housing. The translation element translates relative to the housing, and is further adapted to simultaneously rotate and translate relative to the housing. In this way, the handle 40 can more easily clear the housing 10 so as to rotate the handle 40 without being interposed by the housing 10. Specifically, the translation element is a cam surface (not shown) that engages with handle pins (not shown) which translates the handle away from the door plane as the handle is turned.

To return the handle from the released position to the stored position, a pressing force can then be applied to the handle 10 to compress the first biasing member 80 and return the rod member 84 to the first position 74, pushing the piston 70 in a direction into the latch housing 92, and returning the handle 40 back to the stored position. The second biasing element (not shown) around the mount provides a second biasing force on the handle 40 in a direction in towards the housing 10. After the handle is released from the stored position and let go, the handle 40 returns to an orientation parallel to the door plane. Specifically, the housing provides a stopping portion 38 to support the handle 40. The stopping portion 38 is configured to match the axial movement of the handle as it is turned, to ensure the handle 40 is parallel with the door plane. Otherwise, a constant second biasing force on the handle 40 would pull the handle 40 inward towards and contact the housing 10, damaging the handle 40 and the housing 10. The stopping portion 38 prevents the handle 40 from coming into contact with the housing 10 at any point. In another example, it is envisaged that the handle 40 may remain parallel to the door plane throughout the activation and deactivation of the activation release mechanism.

Specifically, the second biasing element (not shown) provides a second biasing force to resiliently bias the handle 40 into the housing 10. The second biasing element is a torsion spring disposed around the hinge 58 which acts to pull the handle flat towards the door plane. When the activation release mechanism is actuated as described, the first biasing member 80 provides a first biasing force on the handle out of the housing. The second biasing force into the housing 10 is lesser than the first biasing force out of the housing 10. The second biasing force acts to always pull the handle towards the housing. However, when the second biasing force is overcome (i.e. when the activation release mechanism is actuated), the handle 40 can be biased from its stored position to a released position, where the handle remains parallel to the plane of the housing outer surface, which is also the plane of the door.

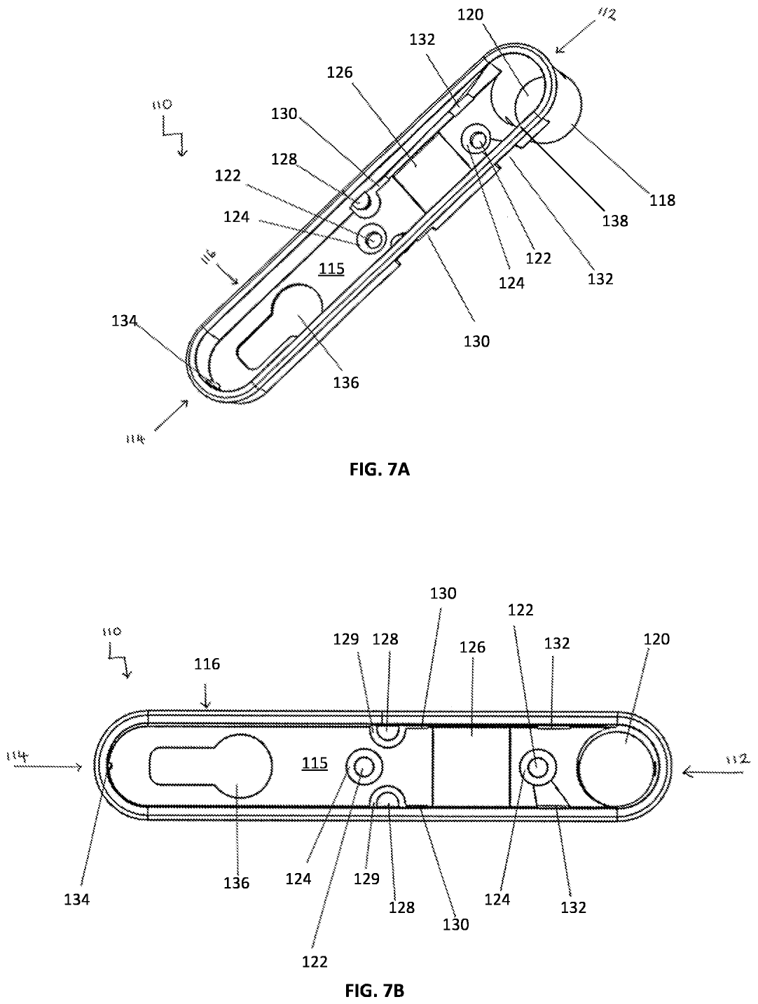

FIG. 7A illustrates a front perspective view of a housing 110 having substantially the same features as housing 10 as previously described and FIG. 7B illustrates a front view of same. Additionally, the housing 110 comprises a housing aperture 136 shaped as a keyhole located on the recessed surface 115 of the handle. In this example, the housing aperture 136 is shaped as a keyhole, however it should be appreciated that the housing aperture 136 may take the form of other shapes according to the present disclosure.

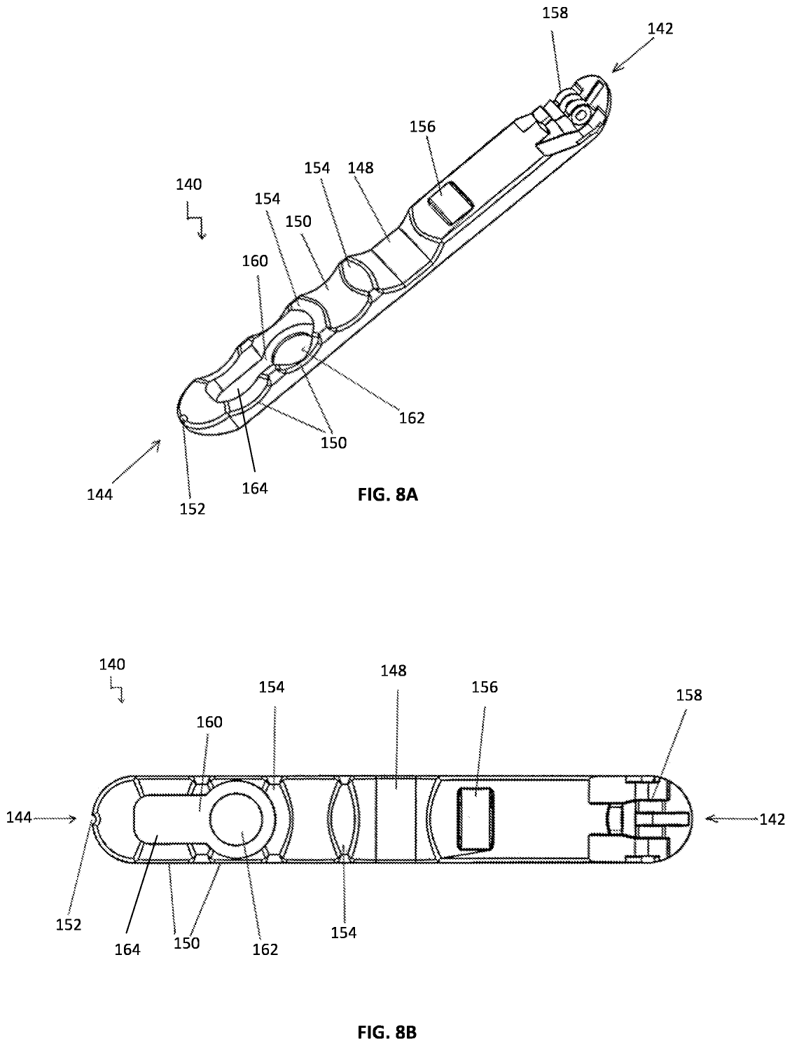

FIG. 8A illustrates a front perspective view of a handle 140 having substantially the same features as handle 10 as previous described and FIG. 8B illustrates a front view of same. The handle 140 has a keyhole shaped depression 164 disposed on a rear facing surface at the distal end 144 of the handle 140. The depression 164 comprises a handle aperture 162.

When the handle 140 is received and stored inside the housing 110, the housing aperture 136 and the handle aperture 162 are concentrically aligned, allowing a locking element (not shown) to be inserted into the housing aperture 136 and the handle aperture 162 to lock the handle 140 in the stored position within the housing 110. When the locking element (not shown), which in this example is a locking key, is received in this way, even when the user applies a pressing force to the front surface of the handle 140 with an intention to actuate the activation release mechanism and release the handle 140 from the housing 110, the handle 140 will remain in the stored position. In this example, the locking element is a locking key, however it should be envisaged that the locking element can be a pin, a rod, or any element that can be received in the apertures 162, 136 according to the present invention. The locking element may be removed so that the handle 140 can be released from the housing 110 by the activation release mechanism. If the locking element is received in the apertures 162, 136, the door cannot open.

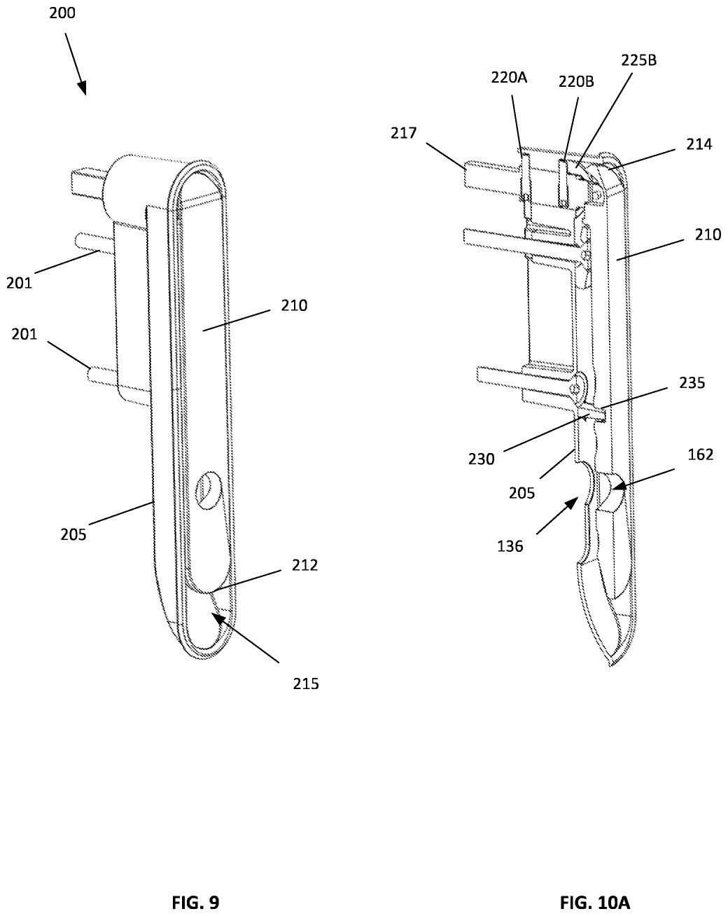

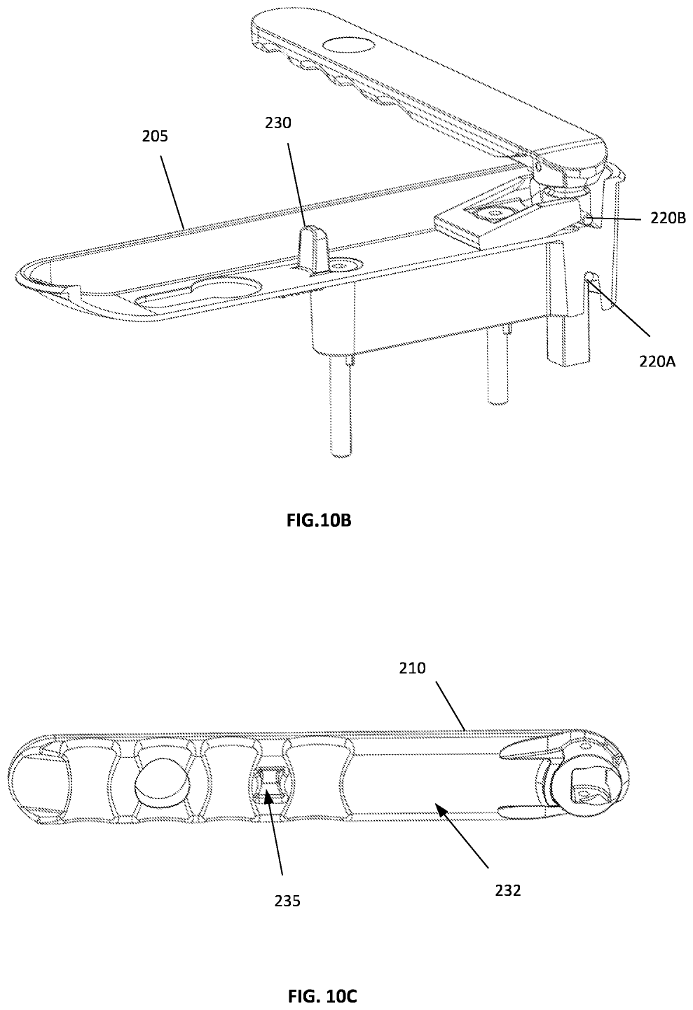

FIG. 9 illustrates an alternative handle assembly. As shown in FIG. 9, the handle assembly 200 includes a housing 205 and a handle 210 secured thereto. Screws 201 allow the handle assembly 200 to be secured to the frame of a door, such as in a folding door system. An alternative activation release mechanism is formed by providing a gap 215 between an end 212 of the handle 210 and the housing 205. The gap 215 provides a way for the user to insert a finger to grip the handle 210 and pull the handle 210 from the stored inoperable position. Whilst providing a gap 215 between the handle 210 and the housing 205 is one way of providing a pull latch to release the handle 210, it would be apparent that the pull latch may be formed by other means such as a tab or recess or aperture formed in or on the handle 210. The pull latch enables the user to easily pull the handle 210 free from the housing 205 to operate the handle assembly 200. This is in contrast to the activation release mechanism incorporating a push latch as described above, where the user presses the latch to release the handle from the housing. The handle assembly 200 of FIG. 9 relies on a user, rather than a biased system, to release the handle from the stored position. The housing aperture 136 and the handle aperture 162 illustrated in FIG. 10A function in the same manner as described above in relation to FIGS. 7A and 8B.

As illustrated in FIGS. 10A to 100 the housing 205 has a protrusion 230 which extends into a cavity defined by the walls of the housing 205, and the handle 210 has a rear surface 232 and a recess 235 formed on the rear surface 232. The recess 235 is arranged to receive the protrusion 230 when the handle 210 is returned to the closed position. As described above, a torsion spring is preferably used to bias the handle 210 towards the housing 205. As the protrusion 230 is received by the recess 235, this acts as a stop, which limits the extent to which the handle 210 can recess into the housing 205. If the handle 210 were not limited in this way, it could recess excessively into the housing 205, thus making it difficult for the user to grip the handle 210 to operate the pull latch. The inter-engaging protrusion 230 and recess 235 therefore enable the user to easily grip the end 212 of the handle 210 to release the handle 210 from the stored inoperable position to the released operable position. Whilst the illustrated example describes the handle 210 having the recess 235 and the housing 205 having the protrusion 230, it would be apparent that the handle 210 may have the protrusion 230 and the housing 205 may have the recess 235. It is the inter-engagement between the protrusion 230 and the recess 235 that controls the extent to which the handle 210 can recess into the housing 205.

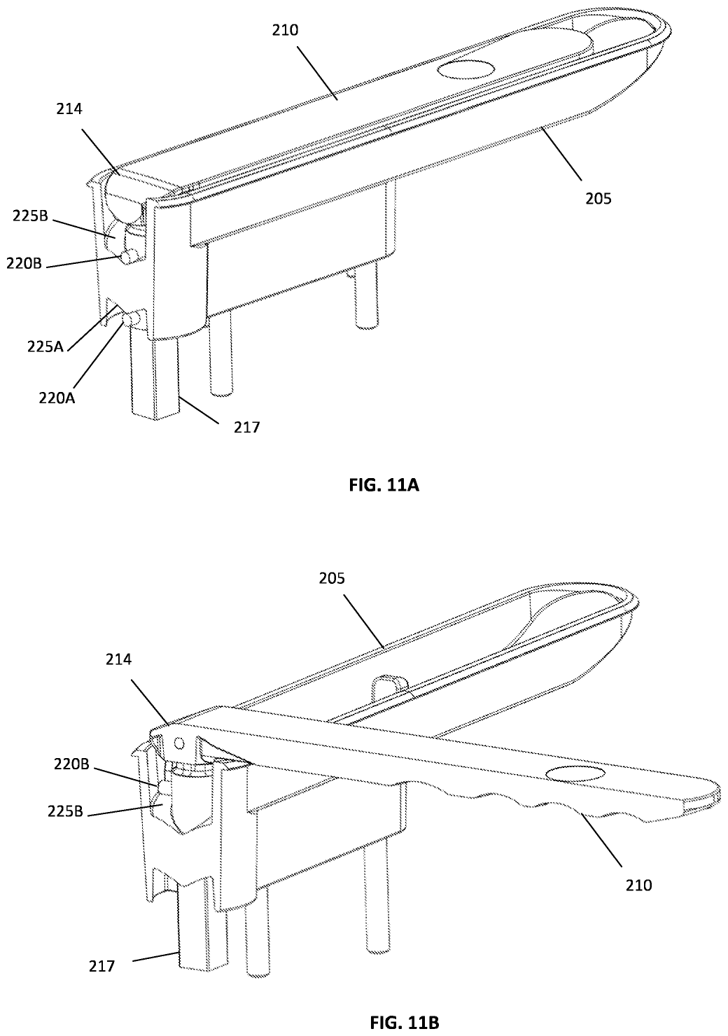

As shown in FIGS. 11A and 11B, the handle 210 is secured to a bolt 217 at a second end 214, and the bolt 217 has two pins 220A, 220B secured thereto in a direction perpendicular to the longitudinal axis of the bolt 217. The two pins 220A, 220B engage with corresponding cam profiles 225A, 225B provided on the housing 205. It should be noted that the pins 220A, 220B and corresponding cam profiles 225A, 225B operate in a similar manner to those described above in relation to the mount and handle pins describe above in relation to the handle assemblies illustrated in FIGS. 1 to 8B. As the user releases the handle 210 from the stored position and rotates the handle 210 about the longitudinal axis of the bolt 217 to the open position, the pins 220A, 220B slide along their respective cam surfaces 225A, 225B and cause the handle 210 to rotate and translate accordingly. The pins 220A, 220B and corresponding cam surfaces 225A, 225B make up the cam system. As the user initially pulls the end 212 away from the housing 205, the handle 210 pivots relative to the bolt 217 about an axis perpendicular to the longitudinal axis of the bolt 217. As the user then rotates the handle 210 from the initially released position, the movement of the pins 220A, 220B over the cam surfaces 225A, 225B causes the second end 214 to rotate about and extend along the longitudinal axis of the bolt 217 such that the second end 214 is translated out of the housing 205 to the position illustrated in FIGS. 10B and 11B. The handle 210 is thus simultaneously rotated and translated by the cam system. Whilst a pair of pins 220A, 220B arranged on opposed sides of the housing 205 are shown, it would be apparent this was not essential. In some cases, a single pin extending into a slot would be equally suitable for achieving the desired motion of the handle. Using a pair of pins 220A, 220B prevents the pins 220A, 220B from separating from their respective cam surface 225A, 225B as the user rotates the handle 210. This advantageously provides greater control over the translation and rotation of the handle 210 during operation of the handle assembly 200. Furthermore, whilst the cam surfaces 225A, 225B are illustrated as forming part of the housing 205, it would be apparent that in some cases the cam surface 225A, 225B may be provided on a separate cam element, such as the mount described above in relation to FIGS. 1 to 8B. In a folding door system, hinges connecting adjacent doors define the spacing between adjacent doors are stacked (i.e. when the hinge is opened to 180 degrees). It is therefore desirable to limit the extension of the handle 210 out of the housing 205 so that adjacent doors can be stacked more closely together when the doors are fully opened. By defining how far the cam surfaces 225A, 225B extend along the longitudinal axis of the bolt 217, it is possible to control how far the handle 210 extends beyond the surface of the housing 205 when rotated to 90 degrees. Furthermore, the torsion spring which biases the handle 210 towards the housing 205, also prevents the handle 210 from extending undesirably beyond the surface of the housing 205. In one example, the cam surfaces 225A, 225B extend approximately 10 mm along the longitudinal axis of the bolt 217 in an outward direction. This causes the handle 210 to translate by approximately 10 mm from the surface of the housing 205 when rotated by 90 degrees from the stored position. It would be apparent that 10 mm was provided merely as an example, and that other handle translations could be selected to match other spacings between stacked doors. In some cases, the handle translation may be less than the spacing between stacked doors to ensure the handle does not clash with an adjacent door when stacked. In some cases, the cam surfaces 225A, 225B may extend by up to 10 mm along the longitudinal axis of the bolt 217 in an outward direction.

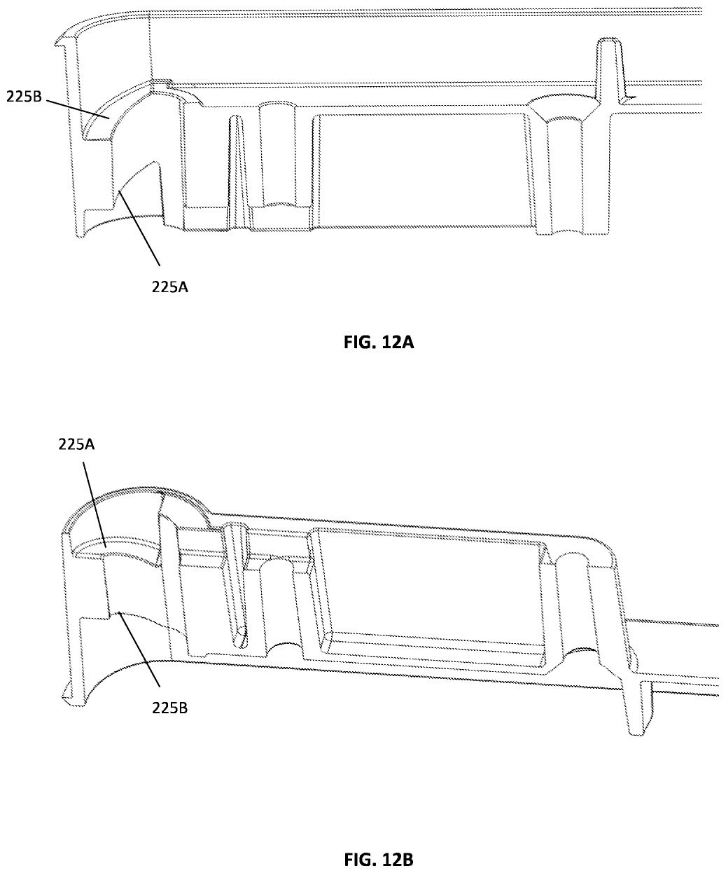

The cam surfaces 225A, 225B are further illustrated in FIGS. 12A and 12B. FIGS. 12A and 12B show cross-sectional views of the housing in isolation from the remaining components of the handle assembly 200 for clarity. The illustrated cross-section is about a plane of symmetry of the housing 205, and thus, a corresponding part of the cam surfaces 225A, 225B has been omitted from view. As shown in FIG. 12A, cam surface 225A may be considered an inner cam surface as it will be further inside the frame compared to cam surface 225B in the assembled door. The cam surfaces 225A, 225B are arranged in a substantially helical arrangement around the longitudinal axis of the bolt 217 to enable the pins 220A, 220B to rotate about and translate along the longitudinal axis of the bolt 217. The cam surfaces 225A, 225B. This achieves a similar motion to that provided by the rotation and translation mechanism described above in relation to the handle assembly of FIGS. 1 to 8B. Whilst the pins 220A, 220B are described as being secured to the handle 210, via the bolt 217, it would be apparent that the pins may be secured to, or be integral to, the housing 205 and extend towards corresponding cam surfaces formed on or in the body of the bolt 217.

It will be clear to a person skilled in the art that features described in relation to any of the embodiments described above can be application interchangeably between the different embodiments. The embodiments described above are examples to illustrate various features of the invention.

Throughout the description and claims of this specification, the words “comprise” and “contain” and variations of them mean “including but not limited to”, and they are not intended to (and do not) exclude other moieties, additives, components, integers or steps.

Through the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect embodiment, or example described herein unless incompatible therewith. All of the features disclosed in this specification (including any accompanying claims, abstract or drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A handle assembly for a door having a locking mechanism comprising:
a handle having at least a front surface;
a housing having a planar outer surface, the housing adapted to receive and store the handle; and
a handle release assembly, comprising an activation release mechanism adapted to selectively move the handle from a stored inoperable position into a released operable position, and a translation mechanism adapted to move the handle rotatably about and axially along an axis normal to the planar surface of the housing during operation.

2. A handle assembly according to claim 1, wherein the activation release mechanism comprises a push latch operatively coupled to a portion of the handle and adapted to selectively operatively engage with the handle and to release the handle from the stored inoperable position.

3. A handle assembly according to claim 2, wherein the push latch comprises at least one first biasing member.

4. A handle assembly according to claim 3, wherein the at least one first biasing member comprises a helical spring operatively engaged with the handle.

5. A handle assembly according to claim 1, wherein the activation release mechanism comprises a pull latch on or in a portion of the handle and configured such that a user can engage the pull latch to release the handle from the stored inoperable position.

6. A handle assembly according to claim 5, wherein the pull latch comprises a tab on the handle.

7. A handle assembly according to claim 5, wherein the pull latch comprises a recess or aperture in the handle.

8. A handle assembly according to claim 5, wherein the housing comprises a protrusion adapted to selectively operatively engage with the handle to prevent the handle recessing into the housing.

9. (canceled)

10. A handle assembly according to claim 8,
wherein the handle comprises a second recess adapted to receive and engage with the protrusion of the housing.

11. A handle assembly according to claim 1, wherein the translation mechanism comprises a first cam system adapted to allow simultaneous movement of the handle rotatably about and axially along the axis normal to the planar surface of the housing during operation.

12. A handle assembly according to claim 11, wherein the first cam system comprises a cam profile provided on the handle cooperatively coupled to a corresponding cam surface provided to the housing.

13. A handle assembly according to claim 1, wherein the handle release assembly further comprises a mount configured to rotatably couple the handle to the housing.

14. A handle assembly according to claim 13, wherein the mount comprises at least one second biasing element configured to resiliently bias the handle towards the housing.

15. (canceled)

16. (canceled)

17. (canceled)

18. A handle assembly according claim 1, wherein when the handle is in the stored inoperable position, the front surface of the handle is arranged substantially flush with the outer surface of the housing.

19. A handle assembly according to claim 1, wherein when the handle is in the stored inoperable position, the front surface of the handle is arranged sub-flush with the outer surface of the housing.

20. A handle assembly according to claim 1, further comprising a stopping portion adapted to operatively engage with the handle.

21. A handle assembly according to claim 1, wherein when the handle is in the stored inoperable position, the front surface of the handle is substantially parallel with the outer surface of the housing.

22. A handle assembly according to claim 1, wherein the housing comprises an attachment portion adapted to operatively receive a corresponding attachment portion of the handle.

23. A handle assembly according to claim 1, wherein when the handle is in the stored inoperable position, the handle is fixed relative to the housing such that the handle cannot rotate therein.

24. (canceled)

25. A handle assembly according to claim 1, wherein when the handle is in the released operable position, the front surface of the handle is substantially parallel with the outer surface of the housing.
